(19) United States
(12) Patent Application Publication
(10) Pub. No.: US 2017/0006295 A1
(43) Pub. Date: Jan. 5, 2017

(54) ENCODING APPRATUS AND METHOD BASED ON VIDEO ANALYSIS

(71) Applicant: IDIS CO., LTD., Daejeon-si (KR)

(72) Inventors: Dong Sang YU, Icheon-si (KR); Nam Hyun CHO, Anyang-si (KR)

(73) Assignee: IDIS CO., LTD., Daejeon-si (KR)

(21) Appl. No.: 14/789,275

(22) Filed: Jul. 1, 2015

(30) Foreign Application Priority Data
Jun. 30, 2015 (KR) 10-2015-0093392

(51) Int. Cl. H04N 19/167; H04N 7/18; H04N 19/517; H04N 19/117; H04N 19/184; H04N 19/23; H04N 19/146; H04N 19/137

(52) U.S. Cl. CPC H04N 19/167; H04N 19/146; H04N 7/18; H04N 19/137; H04N 19/117; H04N 19/184; H04N 19/23; H04N 19/517

(57) ABSTRACT

An encoding method of security images. Provided is a variable bit rate (VBR) control method for controlling a bit rate in encoding an image frame by accumulating at regular intervals the distribution, within the frame, of an amount of movements in foreground images subtracted from the image frame. When the amount of movements is accumulated, the image may be encoded in higher quality regarding to the recent movements by changing the weight value according to time.

### CROSS-REFERENCE TO RELATED APPLICATION(S)

This application claims the benefit under 35 U.S.C. §119(a) of Korean Patent Application No. 10-2015-0093392, filed on Jun. 30, 2015, in the Korean Intellectual Property Office, the entire disclosure of which is incorporated herein by reference for all purposes.

### BACKGROUND

1. Field

The following description relates to video encoding, and more particularly, to encoding technology using variable bit rate for a region of interest (ROI) when a security video is encoded.

2. Description of the Related Art

Region of interest (ROI) encoding represents a method of encoding an ROI, which is set by a user, in higher quality than the surrounding areas when a security video is encoded.

As examples of ROI coding, there is a technology to code the ROI at a high bit rate and the background part excluding the ROI at a low bit rate. There may be two manners to set the ROI. The first is an active ROI coding manner, and the second is a passive ROI coding manner. The passive ROI coding manner is setting a predefined area as an ROI regardless of the change in environment. Such a passive manner is used, for example, when a user sets a specific screen in the case of a CCTV of which the entire screen is fixed. Also, the active manner is using the ROI that is not set in advance but may be changed depending on the environment or the content. For example, for such an active manner, there are the following manners: a manner for setting, as an ROI, an area with a lot of movements by using a motion vector when an image is encoded, and a manner for dividing the image into high and low-frequency areas by using a filter so as to set the high-frequency area as an ROI.

Korean Patent Publication No. 10-2009-0042047, publicized on Apr. 29, 2009, discloses a method of analyzing the complexity of an image and adjusting the bit rate in a frame, and provides a method of detecting ROIs e.g., facial areas and subtitle areas, etc., by using a motion vector when the complexity of the image is analyzed.

In the active ROI coding technology, since the ROI is set as changes in movements are tracked when analyzing the image, there are many cases in which the area where a user is interested at the moment is encoded at a low bit rate, or in which the area that is unnecessary for the interest is encoded at a high bit rate. For example, in detecting the movements using the differentiation between frames, there is a case in which relatively less important part is encoded at a high bit rate because the differentiation has been calculated greatly, due to the influence of the previous frame, from the background area where the object has already passed by.

### SUMMARY

The purpose of the present disclosure is to more reasonably distribute information included in an image through more specific fragmentation, whereas the existing invention has been controlled by dividing the image into two, the movement area and the background, so as to control the bitrate.

In one general aspect, a foreground image is subtracted from an input image, and the distribution, within a frame, of an amount of movements in the foreground image subtracted from the image frame. Then, an accumulation map is generated by calculating a distribution within the frame, of an accumulated value of an amount of movements in foreground images, wherein the amount of movements is calculated at regular intervals. A bit rate for each area is controlled based on the generated accumulation map in encoding an image frame.

The accumulation map, in which the accumulated value for each sub-region is calculated, may be generated by accumulating the amount of movements of the foreground images, wherein the amount of movements has been calculated from each sub-region within a frame in an address corresponding to the sub-region in map memory.

In the case in which the amount of movements of each sub-region of the subtracted foreground images is greater than a threshold, the accumulated value for each sub-region may be calculated by applying the weight value to the amount of movements.

The weight value applied to the amount of movements may be applied more greatly to a recent amount of movements.

An accumulated movement area may be set by calculating a sub-region in which the accumulated value is greater than a reference value in the distribution of an entire accumulated value of the accumulation map.

The movement area may be set by subtracting an area where the calculated amount of movements in the foreground image is greater than the reference value.

A rest of area of the image frame excluding the accumulated movement area and the movement area may be set as a stable area.

A bit rate size of the movement area may be controlled to be greater than a bit rate size of the accumulated movement area, and the bit rate size of the accumulated movement area may be controlled to be greater than a bit rate size of the stable area.

### BRIEF DESCRIPTION OF THE DRAWINGS

FIG. 1 is a simple flowchart illustrating an example of a method of encoding an image through setting an ROI.

FIG. 2 is a flowchart illustrating an example of a method of controlling a bit rate by accumulating an amount of movements in a foreground image.

FIG. 3 is a schematic diagram illustrating a configuration of buffer memory.

FIG. 4 is a schematic diagram illustrating another configuration of buffer memory.

FIG. 5 is a diagram illustrating a configuration of an encoding apparatus for controlling variable bit rate (VBR).

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

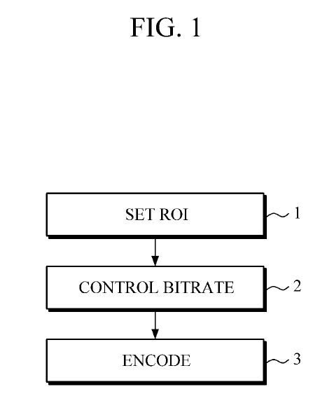

Variable bit rate (VBR) encoding may be applied to software and/or hardware that encode videos. Bit rate is the number of bits that are output per second from an encoder, which compresses video information. General VBR encoding is used to analyze video differences between frames, thereby coding a part having a small amount of movements at a relatively lower bit rate and a part having a large amount of movements at a high bit rate. In contrast, a VBR method in the field of security videos is used to divide a region of interest (ROI) and a non-ROI within one image and compress the ROI in high quality and the non-ROI in low quality, as illustrated in FIG. 1. The ROI may be set in various manners according to the security purposes and application fields.

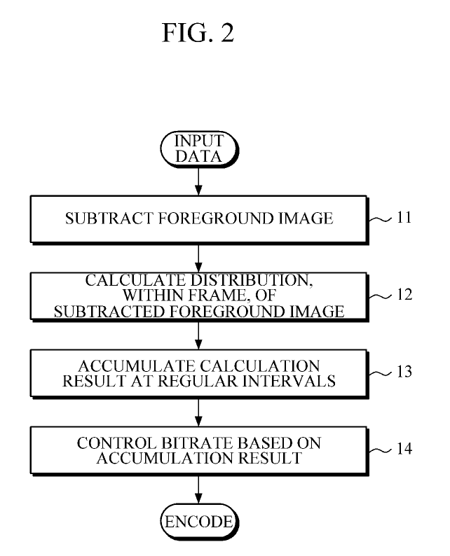

FIG. 2 is a flowchart illustrating an example of a method of controlling a bit rate by accumulating an amount of movements in a foreground image, which is described hereinafter.

A VBR control method may include: subtracting a foreground image from an input image; calculating the distribution, within a frame, of an amount of movements in the foreground image, which have been subtracted from an image frame; generating an accumulation map by calculating the distribution, within the frame, of the accumulated value of the amount of movements in the foreground images, wherein the amount of movements is calculated at regular intervals; and controlling a bit rate based on the generated accumulation map in encoding the image frame.

First, a foreground image may be subtracted from the input image. The foreground image indicates the foreground image of the displayed image that may be changed according to individual image processing. In one exemplary embodiment, background subtraction (BGS) may be used to subtract a foreground image from an input image. The BGS method is to subtract an area, in which there are movements, through differences of image information between continuous image frames under the assumption that the background image is in a stationary state. Accordingly, a background image without movements may be subtracted from input image, and a foreground image may be subtracted by separating the background image, which has been subtracted from the input image. For example, if input data includes an image of a person who gives a lecture in front of a blackboard, the person giving a lecture may be the foreground image because the person is the moving object, and the rest including the background, etc., which does not have movements, may be the background image. Thus, the part, such as the blackboard, etc., may be first set as the background image in an image, and such a background image may be separated from the input image, thereby subtracting the foreground image, which is the person giving a lecture. There are several well-known methods of subtracting a background image in the security field. For example, an area in which there are no movements over a predetermined period of time may be set as a background image. Also, contours i.e. boundary of one or more moving objects in an image frame may be recognized; the area outside the boundary may be processed as the background; and the area inside the boundary may be processed as the foreground. There may be the case in which a part, which has been processed as the background previously, may be processed as the foreground suddenly, such as the case in which a car parked for a few days is suddenly moved.

Then, the distribution, within the frame, of an amount of movements in the foreground image subtracted from the image frame may be calculated in 12. The amount of movements in the foreground may indicate a value acquired by calculating the difference between the foreground image areas of the input image frame and of the previously input image frame. In one example, the distribution, within the frame, of an amount of movements in the foreground image may indicate an amount of movements for each pixel of an area, in which the foreground image exists, of the entire frame. In another example, the distribution, within the frame, of an amount of movements in the foreground image may indicate an amount of movements for each macroblock that is included in an area in which the foreground image exists. The amount of movements for each macroblock may be a sum or average of the amount of movements of each pixel within the block. The amount of movements for each macroblock may indicate a size of the movement vector of each macroblock. A unit to calculate the distribution of the amount of movements may be a pixel, two-or-four pixels, a macroblock, a plurality of macroblocks, or the like. Hereinafter, such a unit to calculate the distribution of the amount of movements is referred to as ‘sub-region’.

Hereinafter, the distribution, within the frame, of an accumulated value of the amount of movements in the foreground images, wherein the mount of movements has been calculated at regular intervals, may be calculated, thereby generating an accumulation map. The distribution, within the frame, of the amount of movements in the foreground may be calculated as mentioned above, wherein such a calculation is repeatedly performed every time input frames are input, and the calculation results are accumulated for each sub-region in buffer memory, thereby generating the accumulation map.

Only the frames that are input at regular intervals are accumulated, thereby applying only the recent movements of the foreground image. The regular intervals may be set by a user and differently according to types of the input data.

The accumulation map may be generated as represented by Equation 1.

$$Y ( t ) = {\sum }_{b = α}^{t - 1} {\sum }_{i , j = 1}^{n} {X}_{ij} ( b ) \qquad [ Equation 1 ]$$

(where Y(t) denotes an accumulation map, X(t) denotes an amount of movements in a foreground image within a frame that is input at t second, i denotes a position of a horizontal axis of a unit area within a frame, j denotes a position of a vertical axis of a unit area within a frame, t denotes the time when a present image frame is input, and t−1 denotes the time when the previous frame is input)

Then, bit rate may be controlled when the image frame is encoded based on the generated accumulation map. A part, in which the large amount of movements accumulated through the accumulation map is detected, is encoded at a high bit rate, thereby making the relevant part into a high-quality image. In contrast, a part, in which the small amount of movements accumulated through the accumulation map is detected, is encoded at a low bit rate, thereby making the relevant part into a low-quality image. The degree of the small or large amount of movements determined based on a threshold or a reference value. The bit rate may be adjusted by the control of quantization of a discrete cosine transform of the macroblock or selection of I, B, and P frames in image coding of an MPEG format.

In an additional exemplary embodiment, an accumulation map, in which the relevant accumulated value for each sub-region is calculated, is generated by accumulating the amount of movements of the foreground images, wherein the amount of movements has been calculated from each sub-region within a frame, in an address corresponding to the sub-region in map memory. As mentioned above, the sub-region is a unit area, in which an amount of movements of the foreground image is calculated and which is a standard for distributing the calculation result within a frame. Such a sub-region may be, for example, a macroblock which is defined in the relevant technical field. The macroblock is a processing unit in image and video compression formats based on linear block transforms, such as the discrete cosine transform. The macroblock may consist of 16×16 samples, be further subdivided into transform blocks, and be further subdivided into prediction blocks. The map memory is a place in which the generated accumulation map is stored. The information of the accumulation map may be updated in the map memory every time the amount of movements of the foreground image is newly calculated. The calculated amount of movements of the foreground image is accumulated along with the amount of movements corresponding to the same sub-region within each frame, as described above. Here, the same sub-region indicates that the address, within the frame, of the sub-region of the accumulation map stored in the map memory corresponds to the address, within the frame, of the sub-region including the amount of movements to be accumulated.

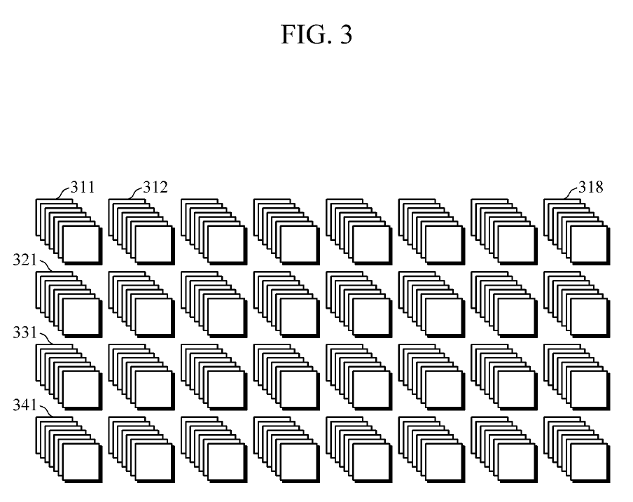

FIG. 3 is a schematic diagram illustrating a configuration of buffer memory. The illustrated exemplary embodiment is exemplary memory space in which an amount of movements of an image with resolution of 4 rows, 8 columns, and 32 sub-regions in total during the period of 6 frames is accumulated. In the exemplary embodiment of FIG. 3, each sub-region is the macroblock consisting of 16×16 pixels. Each of the areas 311, 312, . . . , 318, 321, 322, . . . , 328, 331, 332, . . . , 338, 341, 342, . . . , 348, which correspond to the sub-regions, respectively, may be the buffer memory of seven areas including six memories corresponding to the number of the frames where the amount of movements is accumulated and one memory that stores the sum thereof. For example, each of the areas 311, 312, . . . , 318, 321, 322, . . . , 328, 331, 332, . . . , 338, 341, 342, . . . , 348 is the First-In-First-Out (FIFO) sub-region buffer memory consisting of the seven number of 16-bit words. In the case of an image with 30 frames per second, six frames correspond to the amount of movements for 200 ms. In other words, an ROI is set in consideration with the amount of movements for 200 ms. Such an interval may become long enough to the degree of a few seconds. In such a case, rather than all the frames being accumulated, approx. ten frames per second are sampled so as to accumulate only the amount of movements in the foreground area within the sampled frame.

Such memory space is first initialized to 0. The amount of movements calculated regarding each of the macroblocks is stored in order in the memory address corresponding to the memory space. When recording the frames as many as the number of the predetermined frames in the sub-region buffer is completed, the values of the amount of movements stored in the sub-region buffer corresponding to each sub-region are summed, thereby calculating the accumulated value. The arrangements, in which the accumulated values are stored for each sub-region, form the accumulation map.

Then, if the amount of movements in the foreground image within the frame is calculated, the calculated value is overwritten in the address where the value of the amount of movements is stored. In other words, the sub-region buffer is addressed in a ring method, excluding the summed area. After the overwriting, the accumulated value for each sub-region is calculated again and stored in the summed area. In such a manner, the accumulated value of the amount of movements in the foreground images during the period of the past six frames is continuously calculated based on the current time, thereby acquiring the accumulation map in real time.

In the case in which the calculated amount of movements of each sub-region of the foreground images is greater than a threshold, the accumulated value for each sub-region is calculated by applying the weight value to the amount of movements. The threshold indicates a set value to determine whether the amount of movements in the foreground images is absolutely big for every sub-region. The area in which the amount of movements is greater than the threshold may be more important to a user than other areas or the area where the continuous changes happen recently, thereby applying the weights and accumulating the amount of movements. Generating the accumulation map by applying the weights may be represented by Equation 2 below.

$$Y ( t ) = {\sum }_{b = α}^{t - 1} {\sum }_{i , j = 1}^{n} {α}_{ij} * {X}_{ij} ( b ) \qquad [ Equation 2 ]$$

(where α_ij denotes a weight value.)

When the calculated amount of movements of the foreground image is accumulated in each sub-region, the amount of movements is accumulated by multiplying the amount of movements by the weight value, wherein the greater weight value is multiplied by the recently calculated amount of movements. In other words, the accumulation map is generated by calculating and accumulating the amount of movements of the foreground image at regular intervals, wherein the greater weights than the amount of movements in the previously accumulated frames may be applied to the amount of movements in the frames to be accumulated later at regular intervals. The more recent amount of movements may be more important information to a user within an image, and the even greater weights may be applied because the amount of movements may keep changing later.

Generating an accumulation map by applying the weight may be represented by Equation 3.

$$Y ( t ) = {\sum }_{b = α}^{t - 1} {\sum }_{i , j = 1}^{n} {α}_{ij} ( b ) * {X}_{ij} ( b ) \qquad [ Equation 3 ]$$

(where 0<α_ij (t)<1)

α_ij (t) in Equation 3 is a value that changes according to the time differently from α_ij in Equation 2. Also, in the case of the same i and j, the bigger the t value, the bigger the α_ij value.

An accumulated movement area may be set by calculating a sub-region in which the accumulated value is greater than a reference value in the distribution of the entire accumulated value of the accumulation map. The reference value indicates a set value to determine whether the amount of movements in the foreground images, calculated and accumulated at regular intervals, is absolutely big for every sub-region. The reference value to set the accumulated movement area may be changed according to the types of the input image. For example, in the case in which the input image has large changes for every frame, such as action movies, the reference value may be set to be big so as to prevent the areas of all the images from being set as the accumulated movement area. Alternatively, in the case of the input image for observing the subtle changes, such as one blooming flower with the background of the wide lawns, the reference value may be set to be small so that even a small change of the blooming flower bud may be set as the accumulated movement area. The accumulated movement area may be an area where, in response to the result acquired by calculating the amount of movements in the foreground images at regular intervals, the continuous movements are observed, or may be an area having the non-continuous but very big changes in the foreground image in the previous frame. Accordingly, the accumulated movement area may be the area in which a user is interested, or the important area to a user.

The movement area may be set by subtracting an area where the calculated amount of movements in the foreground image is greater than the reference value. Here, the reference value indicates a set value to calculate the amount of movements in the foreground images for every sub-region of the frame every time the image frame is input, thereby determining whether the calculated amount is absolutely big. The amount of movements in the foreground images within the currently input image frames is calculated so as to determine whether the calculation result is greater than a reference value before the calculation result is accumulated in the accumulation map. In other words, the calculation result of the amount of movements within the present image frame is accumulated in the accumulation map when the following image frame is input. If the calculation result of the amount of movements is determined to be greater than the reference value, the relevant is set as the movement area. The movement area is set based on the amount of movements of the currently input image frame. Accordingly, the movement area may be the area in which a user is interested, or the most important area to a user.

The rest of the area of the image frame excluding the accumulated movement area and the movement area may be set as a stable area. The stable area is where there are small changes in the foreground image in the input image or there is no change. The stable area is encoded at the lowest bit rate compared to other areas, which will be described later.

The bit rate size of the movement area may be controlled to be greater than the bit rate size of the accumulated movement area, of which the bit rate size may be controlled to be greater than the bit rate size of the stable area. As described above, since the movement area is where there are currently the biggest changes in the foreground image in the input image, the movement area is the most important and interesting to a user. The largest bit rate among the movement area, the accumulated movement area, and the stable area is applied, thereby encoding the movement area into the high-quality image. The accumulated movement area is calculated by accumulating the changes in the foreground images of the frame immediately before the currently input image frame, wherein the accumulated movement area is also the important area to a user because there are continuous changes. However, since the most important area is the movement area as described above, the bit rate higher than the stable area is applied to the accumulated movement area, but the lower bit rate than the movement area is applied. Since the stable area is where there are no changes in the foreground image or a slight change therein, the lowest bit rate of the above-mentioned areas is applied.

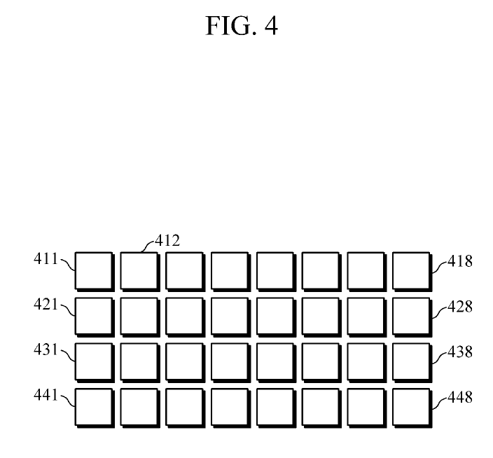

FIG. 4 is a schematic diagram illustrating′ another configuration of buffer memory. The illustrated exemplary embodiment is exemplary memory space in which an amount of movements of an image with resolution of 4 rows, 8 columns, and 32 sub-regions in total during the period of 6 frames is accumulated. In the exemplary embodiment of FIG. 4, each sub-region is the macroblock consisting of 16×16 pixels. Each of the areas 411, 4312, . . . , 418, 421, 422, . . . , 428, 431, 432, . . . , 438, 441, 442, . . . , 448, which correspond to the sub-regions, respectively, may be the memory where the amount of movements is accumulated. For example, each of the areas 411,4312, . . . , 418, 421, 422, . . . , 428, 431, 432, . . . , 438, 441, 442, . . . , 448 is the sub-region buffer memory of 32-bit words. In the case of an image with 30 frames per second, six frames correspond to the amount of movements for 200 ms. In other words, an ROI is set in consideration with the amount of movements for 200 ms. Such an interval may become long enough to the degree of a few seconds. In such a case, rather than all the frames being accumulated, approx. ten frames per second are sampled so as to accumulate only the amount of movements in the foreground area within the sampled frame.

Such memory space is first initialized to 0. The amount of movements calculated regarding each of the macroblocks is stored in the memory address corresponding to the memory space. The amount of movements calculated regarding each of the macroblocks of the foreground image, subtracted from the following frame, is accumulated in the corresponding sub-region memory. The arrangements, in which the accumulated values are stored for each sub-region, form the accumulation map. If the accumulated values regarding the predetermined number of frames, such as the six frames, are continuously accumulated in the sub-region memories, a predetermined value, empirically set through the accumulation, regarding the following frame is subtracted from all the sub-region memories. However, the value stored in the sub-region memory is not negative. The constant value is set to be properly small not to make difficult the determination regarding the distribution, within a frame, of the accumulated value of the movements. For example, the constant value is acquired by dividing, by the number of frames, the accumulated value of the amount of movements in the foreground images on the frames where the value is to be accumulated.

In the case in which the calculated amount of movements of each sub-region of the foreground images is greater than a threshold, the weight value is applied to the amount of movements, thereby calculating the accumulated value for each sub-region. The threshold indicates a set value to determine whether the amount of movements in the foreground images is absolutely big for every sub-region. The area in which the amount of movements is greater than the threshold may be more important to a user than other areas or the area where the continuous changes happen recently, thereby applying the weights and accumulating the amount of movements. Generating the accumulation map by applying the weights may be represented by Equation 4 below.

$$Y ( t ) = {\sum }_{b = α}^{t - 1} {\sum }_{i , j = 1}^{n} {α}_{ij} * {X}_{ij} ( b ) \qquad [ Equation 4 ]$$

(where α_ij denotes a weight value)

An accumulated movement area may be set by calculating a sub-region in which the accumulated value is greater than a reference value in the distribution of the entire accumulated value of the accumulation map. The reference value indicates a set value to determine whether the amount of movements in the foreground images, calculated and accumulated at regular intervals, is absolutely big for every sub-region. In one exemplary embodiment, the reference value to set the accumulated movement area may be changed according to the types of the input image. The accumulated movement area may be an area where, in response to the result acquired by calculating the amount of movements in the foreground images at regular intervals, the continuous movements are observed, or may be an area having the non-continuous but very big changes in the foreground image in the previous frame. Accordingly, the accumulated movement area may be the area in which a user is interested, or the important area to a user.

The movement area may be set by subtracting an area where the calculated amount of movements in the foreground image is greater than the reference value. Here, the reference value indicates a set value to calculate the amount of movements in the foreground images for every sub-region of the frame every time the image frame is input, thereby determining whether the calculated amount is absolutely big. The amount of movements in the foreground images within the currently input image frames is calculated so as to determine whether the calculation result is greater than a reference value before the calculation result is accumulated in the accumulation map. In other words, the calculation result of the amount of movements within the present image frame is accumulated in the accumulation map when the following image frame is input. If the calculation result of the amount of movements is determined to be greater than the reference value, the relevant is set as the movement area. The movement area is set based on the amount of movements of the currently input image frame. Accordingly, the movement area may be the area in which a user is interested, or the most important area to a user.

The rest of the area of the image frame excluding the accumulated movement area and the movement area may be set as a stable area. The stable area is where there are small changes in the foreground image in the input image or there is no change. The stable area is encoded at the lowest bit rate compared to other areas, which will be described later.

The bit rate size of the movement area may be controlled to be greater than that of the accumulated movement area, of which the bit rate size may be controlled to be greater than that of the stable area. As described above, since the movement area is where there are currently the biggest changes in the foreground image in the input image, the movement area is the most important and interesting to a user. The largest bit rate among the movement area, the accumulated movement area, and the stable area is applied, thereby encoding the movement area into the high-quality image. The accumulated movement area is calculated by accumulating the changes in the foreground images up to the immediately preceding frame before the currently input image frame, wherein the accumulated movement area is also the important area to a user because there are continuous changes. However, since the most important area is the movement area as described above, the bit rate higher than the stable area is applied to the movement area, but the lower bit rate than the movement area is applied. Since the stable area is where there are no changes in the foreground image or a slight change therein, the lowest bit rate of the above-mentioned areas is applied.

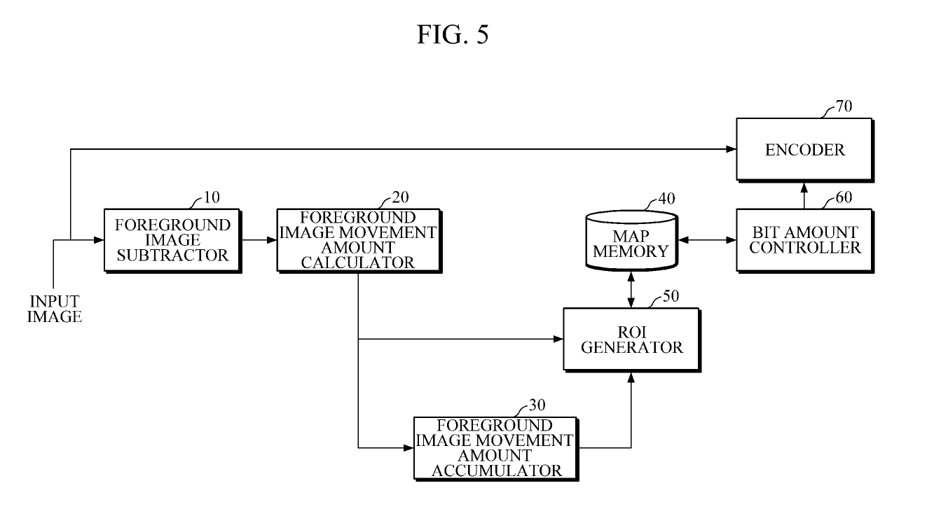

FIG. 5 is a diagram illustrating a configuration of an encoding apparatus for controlling variable bit rate (VBR). As illustrate in FIG. 5, the encoding apparatus may include a foreground image subtractor 10, a foreground image movement amount calculator 20, a foreground image variance accumulator 30, map memory 40, an ROI generator 50, a bit amount controller 60, and an encoder 70.

The foreground image subtractor 10 may subtract the foreground image from the input image. For example, the foreground image subtractor 10 may use background subtraction (BGS) to subtract the foreground image from the input image. The BGS is the same as described above, and accordingly, the foreground image subtractor 10 may subtract the background image without movements from the input image and separate the background image, which has been subtracted from the input image, thereby subtracting a foreground image. The subtracted foreground image is transmitted to a foreground image movement amount calculator 20.

The foreground image movement amount calculator 20 may calculate the distribution, within the frame, of the amount of movements in the foreground image subtracted from the image frame. Accordingly, to calculate the amount of movements in the foreground image, the amount of movements is calculated by using the foreground image subtracted from the present image frame and the foreground image of the previous frame of the relevant frame.

The foreground image movement amount accumulator 30 calculates the accumulated value of the amount of movements in the foreground image calculated at regular intervals.

The ROI generator 50 may set the movement area based on information of the amount of movements in the present frame, which is transmitted from the foreground image movement amount calculator 20, and may set the accumulated movement area based on the information transmitted from the foreground image movement amount accumulator 30. Also, a stable area is set based on the two areas, thereby recording the set accumulation map in the map memory 40.

The bit amount controller 60 may control the bit rate in encoding the image frame based on the accumulation map information stored in the map memory 40. The area is set at the ROI generator 50; the biggest bit rate is applied to the movement area by using the accumulation map stored in the map memory 40; the next biggest bit rate, the accumulated movement area; and the lowest bit rate, a stable area, thereby encoding the areas, which are more important to a user and which have more recent movements, into the high-quality image.

In actively executing the ROI coding, image analysis information is accumulated and used, thereby generating the optimum ROI with a small amount of calculations. Furthermore, the weight value is changed when information is accumulated, thereby enabling the ROI to be applied to an area with recent large amount of movements and changed. Accordingly, the encoded video is capable of providing more reasonable distribution than the amount of information depending on the importance for each area.

Descriptions incorporated herein is omitted to enhance clarity and conciseness, and similar reference numerals are used to refer to similar elements, features, and structures throughout the drawings and the detailed description. The description that one portion ‘comprises’ one element does not indicate that other elements are excluded, but it indicates other elements are further included if there are not the descriptions against the present disclosure. In addition, the components, devices, and units described herein indicates “a block configured to enable the systems of hardware or software to be changed or plugged in”, which is, in other words, one unit or block that performs functions in hardware or software.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A variable bit rate (VBR) control method, wherein comprises a method of encoding a variable bit rate of a security image, the method comprising:
subtracting a foreground image from an input image;
calculating a distribution, within a frame, of an amount of movements in the foreground image subtracted from an image frame;
generating an accumulation map by calculating a distribution, within the frame, of an accumulated value of an amount of movements in foreground images, wherein the amount of movements is calculated at regular intervals; and
controlling a bit rate for each area based on the generated accumulation map in encoding an image frame.

2. The A variable bit rate (VBR) control method of claim 1, wherein the generating of the accumulation map comprises generating the accumulation map, in which the accumulated value for each sub-region is calculated, by accumulating the amount of movements of the foreground images, wherein the amount of movements has been calculated from each sub-region within a frame in an address corresponding to the sub-region in map memory.

3. The variable bit rate (VBR) control method of claim 1, wherein the generating of the accumulation map comprises, in the case in which the amount of movements of each sub-region of the subtracted foreground images is greater than a threshold, calculating the accumulated value for each sub-region by applying the weight value to the amount of movements.

4. The variable bit rate (VBR) control method of claim 1, wherein the generating of the accumulation map comprises, when the calculated amount of movements of the foreground image is accumulated in each sub-region, accumulating the amount of movements by multiplying the amount of movements by the weight value, wherein a greater weight value is multiplied by a recently calculated amount of movements.

5. The variable bit rate (VBR) control method of claim 1, wherein the controlling of the bit rate comprises setting an accumulated movement area by calculating a sub-region in which the accumulated value is greater than a reference value in the distribution of an entire accumulated value of the accumulation map.

6. The variable bit rate (VBR) control method of claim 5, wherein the controlling of the bit rate comprises setting a movement area by subtracting an area where the calculated amount of movements in the foreground image is greater than the reference value.

7. The variable bit rate (VBR) control method of claim 6, wherein the controlling of the bit rate comprises setting, as a stable area, a rest of area of the image frame excluding the accumulated movement area and the movement area.

8. The variable bit rate (VBR) control method of claim 7, wherein the controlling of the bit rate further comprise controlling a bit rate size of the movement area to be greater than a bit rate size of the accumulated movement area, and controlling the bit rate size of the accumulated movement area to be greater than a bit rate size of the stable area.

9. A variable bit rate (VBR) control apparatus, wherein comprises an apparatus for encoding a variable bit rate of a security image, the apparatus comprising:
a foreground image subtractor configured to subtract a foreground image from an input image;
a foreground image movement calculator configured to calculate a distribution, within a frame, of an amount of movements in the foreground image subtracted from an image frame;
a foreground image movement amount accumulator configured to accumulate an amount of movements in foreground images, wherein the amount of movements has been calculated at regular intervals;
a region of interest (ROI) generator configured to generate a movement map by calculating the distribution that is calculated by the foreground image movement calculator, and generate an accumulation map by calculating a distribution, within the frame, of an accumulated value of the amount of movements in the foreground image; and
a bit amount controller configured to control a bit rate in encoding an image frame according to a set ROI.
